(19) United States
(12) Patent Application Publication
(10) Pub. No.: US 2019/0186677 A1
(43) Pub. Date: Jun. 20, 2019

(54) FROST PREVENTION MACHINE SUPPORT WITH ADJUSTABLE BOTTOM STRUCTURE

(71) Applicant: JiangSu University, Jiangsu (CN)

(72) Inventor: Lili DONG, Jiangsu (CN)

(73) Assignee: JiangSu University, Jiangsu (CN)

(21) Appl. No.: 16/099,683

(22) PCT Filed: Mar. 28, 2017
(86) PCT No.: PCT/CN2017/078358

§ 371 Date: Nov. 7, 2018

(30) Foreign Application Priority Data
May 9, 2016 (CN) 201610297761.7

(51) Int. Cl. F16M 5/00; F16M 7/00; A01G 13/08

(52) U.S. Cl. CPC F16M 5/00; A01G 13/08; F16M 7/00

(57) ABSTRACT

The present invention disclosed a frost prevention machine support with an adjustable bottom structure, including a frost prevention machine, a connecting support, a base, and a base bolt. The connecting support is composed of an anti-tilting guide barrel, a fixed strut, a rib plate, and a connecting plate. The base seat formed by assembling a base plate, a rotary plate, a guide rod, and a direction control pin shaft. The base plate and the rotary plate are connected through the guide rod, and the base plates are connected through an upper connecting ring and a lower connecting ring. Each guide rod is mounted in two guide grooves of a corresponding base plate. The base bolt is used for fixedly connecting the connecting support and the base seat.

### BACKGROUND

### Technical Field

The present invention relates to a device for the frost prevention machine column, which specifically relates to a fixed device and method of a stand column of the frost prevention machine used in tea (fruit) garden, which belongs to the field of agricultural machinery and technology.

### Description of Related Art

China has a long history of tea planting and drinking. The growth and development of tea trees requires a warm and moist climate. The germination of tea buds in early spring is easy to be affected by cold spell in later spring, which reduces quality and production of the tea. In recent years, research on tea tree frost prevention technology has been carried out rapidly in China. The research shows that frost prevention effect can be achieved by using the frost prevention machine to conduct the airflow disturbance from top to bottom.

At present, commonly used methods for fixing the frost prevention machine column are as below. (1) Digging a pit with a certain depth of a location where the frost prevention machine is installed in a manual way. Pouring concrete in the pit, and a top of the concrete is provided with an anchor bolt. A column bottom flange is fixed on a foundation of the concrete by the anchor bolt. The disadvantage of this method is that labor intensity is high, and installation efficiency of the frost prevention machine is low. (2) Use tools to dig pit with a certain depth and a diameter slightly larger than a diameter of the column in the location where the frost prevention machine is installed. The frost prevention machine column is placed in the pit with a body of the column being kept upright, and is buried via filling of soil or concrete after adjusting the direction. The disadvantage of this method is that: in order to guarantee working requirement of the column, the pit can only has the diameter slightly larger than that of the column, such that in late burying, a gap between soil and column is hard to eliminate. The gap will further increase due to vibration and wind generated from the frost prevention machine in the process of using machine, this severely reduces safety usage of using the frost prevention machine performance and work efficiency. To solve the problem of high labor intensity and low efficiency of digging the pit, the present invention provides the base plate punched into the soil to replace the deep pit fixing frost prevention machine, which greatly reduce the labor intensity and improved the installation efficiency of the frost prevention machine. In addition, through search, Chinese utility model patent CN201120394200.1 discloses a fixing device for a stand column of a frost prevention machine for plant, which includes several root stand mechanisms disposed at a bottom of the stand column. The root stand mechanisms include a steel root beam formed by a metal sheet beam transversely bent into trough type, and a U-shaped hoop. A pair of positioning rods is disposed on a middle of the steel root beam. A lower part of the column is positioned between a bunch of positioning rods, which are fixed vertically to the steel root beam through the U-shaped hoop. This method requires digging larger and deeper pits, which increase the labor intensity, and requirement of installation of the device itself is high and cost is relatively high. The common feature of the above method is that it is necessary to dig a small diameter and high precision deep pit in the installation position of frost prevention machine, and it is labor intensive, time consuming and costly. The present invention adopts the method of driving the base plate to insert into the soil to avoid the work of digging deep pits, thus it reduces the labor intensity, and improves the installation efficiency of the frost prevention machine. The height of frost prevention machine to the ground needs to reach 6.7 meters to meet the frost prevention effect of frost prevention machine. Non-standard pipe is adopted in the conventional frost prevention machine column since the standard length of the pipe is 6 meters, which has a high cost. The use of the connecting support provided by the present invention can make the frost prevention machine column adopt standard pipe material, which can save 50% of the fabricating cost.

### SUMMARY

The purpose of the present invention is to provide a simple frost prevention machine support with an adjustable bottom structure, which has a simple structure and is convenient in installation for reducing labor intensity and installation time of the frost prevention machine, and for effectively preventing sink, rotation, and tilt of the frost prevention machine column, thus it can save manufacturing and material costs to improve economic efficiency, and transportation and storage are also convenient.

The technical solutions of the present invention are as follows.

A frost prevention machine support with adjustable bottom structure includes a frost prevention machine 1, a connecting support 2, base bolts 3, and a base seat 4. The connecting support 2 includes an anti-toppling guide barrel 21, a fixed strut 22, a rib plate 23, and a connecting plate 24. An outer diameter of the anti-toppling guide barrel 21 is 0.5 mm-1 mm smaller than an inner diameter of the fixed strut 22 and an inner diameter of the frost prevention machine column 11. An outer diameter of the fixed strut 22 is equal to the outer diameter of the frost prevention machine column 11. An upper end of the fixed strut 22 is provided with small holes for plug welding. An outer end of the connecting plate 24 is provided with gaps. During the assembly, the anti-toppling guide barrel 21 is first installed into the fixed strut 22 and into the frost prevention column 11 with a length of more than 200 mm. The anti-toppling guide barrel 21 and the fixed strut 22 are fixed by the method of plug welding. The fixed strut 22 is welded vertically in a center of the connecting plate 24. The rib plate 23 is welded between the fixed strut 22 and the connecting plate 24 to enhance anti-torsion ability of the frost prevention machine. The base seat 4 is formed by assembling a base plate 41, a rotary plate 42, and a guide rod 43. The base plates and the rotary plate are rotatably connected between each other. The guide rod 43 is installed in the guide groove 412 on the base plates 41. The base plates are connected through an upper connecting link 44 and a lower connection link 45. When installing base plates 41, dig a shallow pit in a corresponding position. Each base plate 41 and the rotary plate 42 are successively punched into the soil after the location of base plate 41 is determined. When an upper end of the base plates 41 is distant from a bottom side with a height of the rotary plate, punch of the base plates 41 is stopped, and start to exert a downward force to the guide rod 43. During downward movement of the guide rod under exertion of the force, a tip end thereof outwardly pushes the rotary plate 42 to deviate moving direction of the rotary plate and a base fixed plate. Finally, a shape of the base seat is large at bottom and small at top, which is beneficial to stability of the base seat. When an upper end of the guide rod 43 is at the same horizontal position as the base plates 41, a hook end of the connecting bolt is hooked to the upper connecting ring 44, continue ramming downward force to the base plate 41 and the guide rod 43 until a top of the base seat is submerged into a surface of the soil, the holes in the upper end of the guide rod 43 and in the upper end of the guide groove 412 are fixed by the bolt. Afterwards, the connecting support 2 and the base seat 4 are connected and fixed together by the base bolts 3. Finally, the frost prevention machine column 11 is sleeved on the anti-tilting guide barrel 21, and the anti-tilting guide barrel 21 and the frost prevention machine column 11 are fixed by the means of plug welding.

Preferably, a cross-section shape of the fixed part is rectangular.

Preferably, number of the base bolts 4 is 4.

Preferably, numbers of the upper connecting rings 44 and the lower connecting rings 45 are respectively 4.

Preferably, fixing methods between the anti-tilting guide barrel 21 and the fixed strut 22, and between the anti-tilting guide barrel 21 and the frost prevention column 11 are plug welding.

The present invention has simple structure and convenient installation. It reduces labor intensity installing, raises anti-torsion ability and anti-dumping ability, and increases work reliability of the frost prevention machine. The use of connecting support enables standard pipe material to replace non-standard pipe material, which was originally used to meet the height of the frost prevention machine, thereby saving nearly 50% of the cost, also, it facilitates transportation and storage. At the same time, installation efficiency and economic benefits of the frosting prevention machine are improved.

### BRIEF DESCRIPTION OF THE DRAWINGS

FIG. 1 is a schematic overall installation structure view of a frost prevention machine according to the present invention.

FIG. 2 is a schematic structure view of the frost prevention machine according to the present invention.

FIG. 3 is a schematic installation structure view of a connecting support and a base seat according to the present invention.

FIG. 4 is a schematic structure view of the base seat according to the present invention.

FIG. 5 is a schematic installation structure view of a base plate, a rotary plate, and a guide rod according to the present invention.

FIG. 6 is a schematic structure view of the base plates according to the present invention.

FIG. 7 is a schematic structure view of the rotary plate according to the present invention.

FIG. 8 is a schematic structure view of the guide rod according to the present invention.

FIG. 9 is a schematic structure view of base bolts according to the present invention.

### DESCRIPTION OF THE EMBODIMENTS

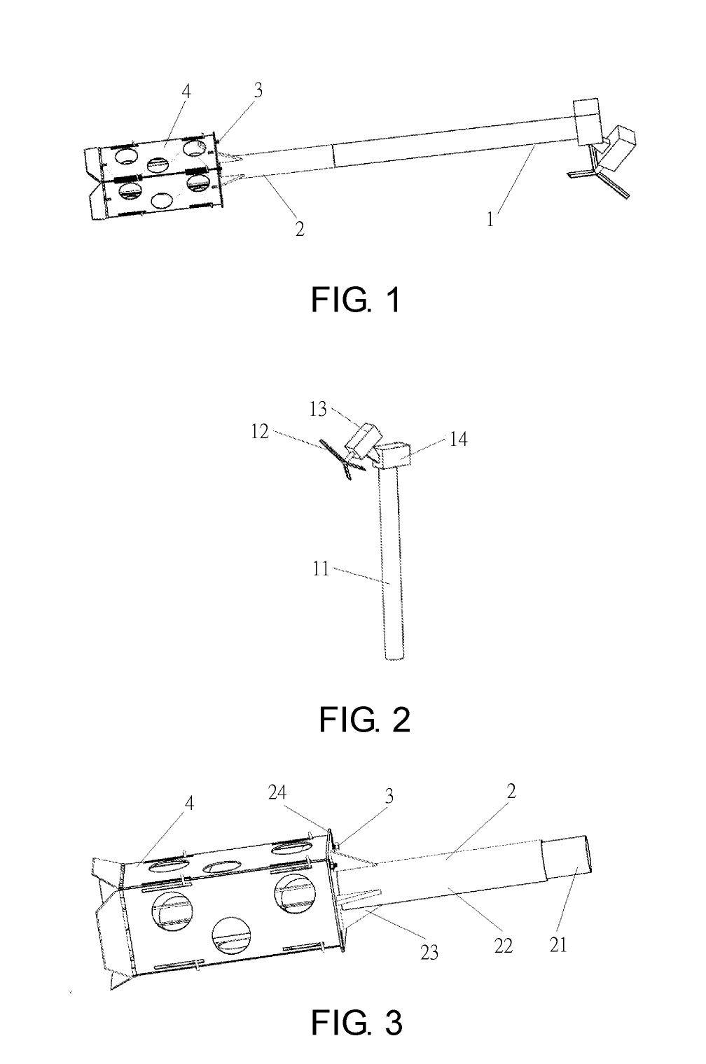

Referring to FIG. 1, the invention includes a frost prevention machine 1, a connecting support 2, base bolts 3, and a base seat 4. The combined installation method meets height requirement and reliability requirement of the frost prevention machine. The frost prevention machine column 11 is sleeved on an anti-tilting guide barrel 21 and is fixed by plug welding. The connecting support 2 and the base seat 4 are fixed by the base bolts 3.

Referring to FIG. 2, the frost prevention machine includes a frost prevention machine column 11, a frost prevention machine blade 12, a frost prevention machine motor 13, and a frost prevention machine connection portion 14. The frost prevention machine column 11 is a standard pipe with a length of 6 m.

Referring to FIG. 3, the connecting support 2 is composed of an anti-tilting guide barrel 21, a fixed strut 22, a rib plate 23, and a connecting plate 24. An outer diameter of the anti-tilting guide barrel 21 is 0.5 mm-1 mm smaller than an inner diameter of the fixed strut 22. Upper end of the fixed strut 22 has 2 or 3 groups of small holes for plug welding. Firstly, the anti-tilting guide barrel 21 is inserted into an upper end of the fixed strut 22 around 200 mm. The anti-tilting guide barrel 21 and the fixed strut 22 are fixed by plug welding. Secondly, the fixed strut 22 is welded vertically in a center of the connecting plate 24, and then the rib plates 23 is welded between the fixed strut 22 and the connecting plate 24 to enhance anti-dumping ability of the fixed strut 22.

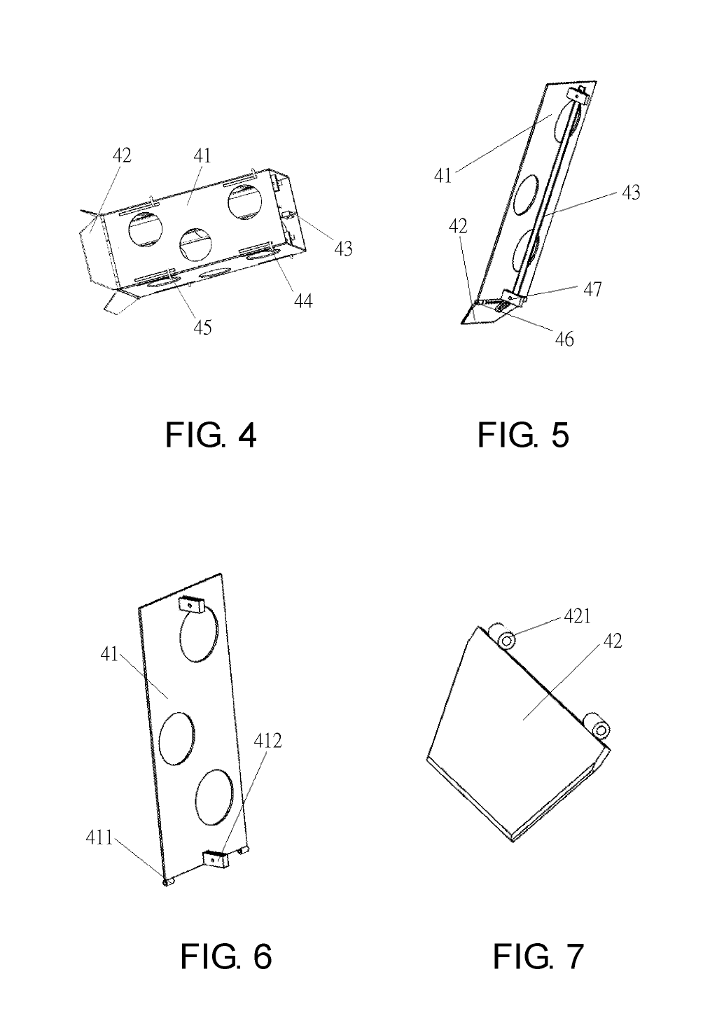

Referring to FIG. 4 and FIG. 5, the base seat 4 formed by assembling a base plate 41, a rotary plate 42, a guide rod 43, and a direction control pin shaft 47. The base plates and the rotating plate are rotatably connected to each other. The guide rod 43 is installed in the guide groove 412 on the base plates 41, with a hole at an upper end of the guide rod 43, and a rotary plate direction control groove at a lower end. Each of the base plates are fastened by an upper connecting link 44 and a lower connection link 45.

Referring to FIG. 6, the base plates 41 are opened with holes, so that the soil inside and outside the base seat 4 are formed into a whole, which improves the stability and reliability of the base seat 4 and the whole frost prevention machine. A lower end is connected with the rotary plate 42, and one side is provided with two guide grooves 412 for installation of the guide rod 43.

Referring to FIG. 7, the rotary plate 42 is designed to be narrow at bottom and wide at top. A wide end of the rotary plate 42 and the base plates 41 are in rotating connection.

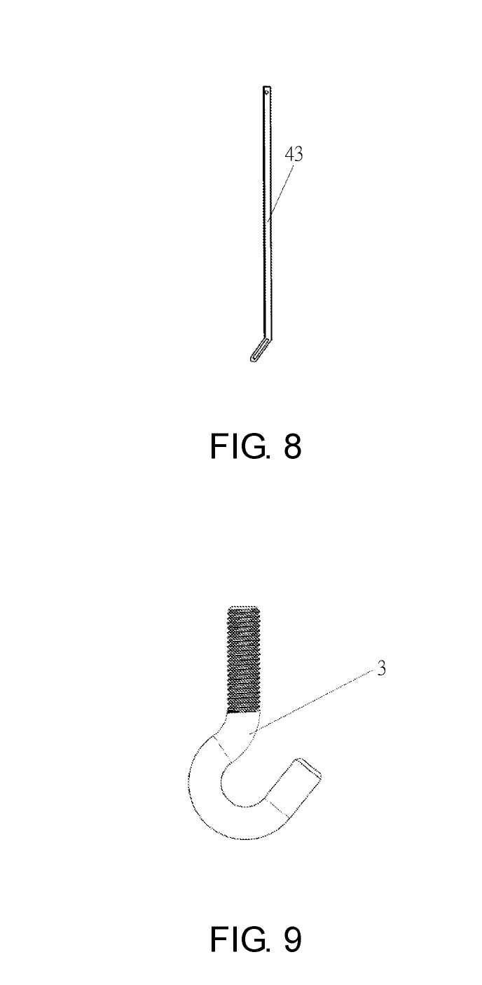

Referring to FIG. 8, a portion below 100 mm of a lower end of the guide rod 43 is deflected 20 degrees relative to an axis direction of the rod. A long strip of rotary plate direction control groove is provided in the section. The upper end of the guide rod 43 is opened with a through hole for bolt mounting, and the lower end of the guide rod 43 is provided with direction control groove

Referring to FIG. 9, a lower end of the base bolts 3 hooks the upper connecting ring 44, and is fixed to the connecting support 2 and the base seat 4 by nut.

The structure, functionality, and processing of the current invention are further described below with reference to the accompanying drawings and the concrete implementation examples. However, the protective range of this present invention includes but not limited to that.

The frost prevention machine support with an adjustable bottom structure according to the present invention can overcome the difficulties of the high precision of digging aperture, deep pit with a small diameter and the backfill compaction in the commonly used fixed installation methods of the frost prevention machine by punching the base seat 4 into the soil, and reduces the labor intensity and improves installation efficiency. The use of connecting support enables the standard pipe can replace the conventional non-standard pipe, which was used to meet the height of the frost prevention machine, thereby greatly saving the fabricating costs, and facilitating to transportation and storage. The hole in the base plate can integrate the soil inside and outside of the base seat into one piece, which enhances the stability of the base seat and reduces the damage to the soil. The present invention provides a device adapted for fixing the frost prevention machine column.

When installing the frost prevention machine. Firstly, the base plates 41, the rotary plate 42, and the guide rod 43 are assembled and formed. The upper connecting ring 44 and the lower connecting ring 45 are mounted, and the relative movement between the base plates 41 is ensured, in order to facilitate each of the base plates 41 to be punched into the soil successively. At the same time, the upper connecting ring 44 also satisfies a gap between hook ends of the base bolts 3 in the ring. Then, dig a pit of 200 mm-300 mm at the position where the frost prevention machine is installed. Each of the base plates 41 and rotary plate 42 are punched into the soil for 50 mm successively after the location of each of the base plate 41 is determined. When an upper end of the base plate 41 is distant from a ground with a height of the rotary plate, suspends punching of the base plate 41 and starts to exert a downward force to the guide rod 43. Fourthly, when the guide rod 43 is exerted by the downward force, the rotary plate direction control groove of a bending part at the bottom of the guide rod 43 is movable along the direction control pin shaft. The bending part generates an outward push force to the rotary plate 42 during outwardly sliding, such that a moving direction of the rotary plate 42 deviates from a vertical direction and point downward. Finally, the shape of the base seat is big at bottom and small at top, which is beneficial to the stability of the base seat. Then, continue to exert downward force on the base plates 41 and the guide rod 43, the base plates 41 and the guide rod 43 are simultaneously submerged into the soil until the top of the base plate is aligned with a surface of the soil, at this time, the upper end of the guide rod is fixed to the guide groove on the upper end of the base plates by bolts, and the hook end of the base bolts upwardly hooks the upper connecting ring 44. Afterwards, adjusting the position of the connecting support 2 on the base seat 4, the upper end of the base bolt 3 is placed in a notch of an edge of the connecting plate 24, and the nut is sleeved on the upper end of the base bolt 3 and is pre-tightened. When the connecting plate 24 attaches a bottom of a shallow pit, use the soil to bury the connecting plate 24. Due to the outer diameter of the anti-tilting guide barrel 21 is 0.5 mm-1 mm smaller than inner diameter of the frost prevention machine column 11, a lower end of the frost prevention machine column 11 has small holes for plug welding. Finally, the frost prevention machine column 11 is sleeved on the anti-tilting guide barrel 21, and the anti-tilting guide barrel 21 and the frost prevention machine column 11 are fixed by the means of plug welding.

The embodiment of the preferred embodiment of the present invention, but the present invention is not limited to the above-described embodiment, without departing from the essential elements of the invention, the field technical personnel able to make any obvious improvement, replace, or variant all belong to the scope of protection of invention.

1. A frost prevention machine support with adjustable bottom structure, the frost prevention machine support comprising: a frost prevention machine, a connecting support, base bolts and a base seat, wherein the connecting support is composed of an anti-toppling guide barrel, a fixed strut, a rib plate, and a connecting plate; the base seat (4) is formed by assembling a base plate, a rotary plate, a guide rod, and a direction control pin shaft, the base plates and the rotary plate are rotatably connected between each other, the base plates are connected through an upper connecting ring and a lower connecting ring, the guide rod is provided with a rotary plate direction control groove, and the base bolts are used for fixedly connecting the connecting support with the base seat.

2. The frost prevention machine support with adjustable bottom structure according to claim 1, wherein two ends of the anti-tilting guide barrel are provided with chamfer, an outer diameter of the anti-tilting guide barrel is 0.5 millimeters-1 millimeter smaller than an inner diameter of the fixed strut and an inner diameter of a frost prevention machine column, to facilitate installation of the anti-toppling guide barrel and the frost prevention machine; the anti-toppling guide barrel is installed into the fixed strut and into the frost prevention machine column with a length of more than 200 millimeters, to ensure reliability of the connection between the three; an outer diameter of the fixed strut is equal to an outer diameter of the frost prevention machine column, and is fixed with plug welding, and the plug holes are 2 or 3 groups.

3. The frost prevention machine support with adjustable bottom structure according to claim 1, wherein upper and lower edges of the base plates has long strip holes which are used to install the upper connecting link and the lower connection link to ensure that the base plates can be connected together without scattering in the process that the base seat is punched into soil, each of the base plates has a guide groove at a center of a single side, which is used to install and control movement of the guide rod; the base plate is provided with holes thereon, which integrate the soil at inner side and outer side into one piece, thus stabilizing the base seat and the solid reliability of the frost prevention machine.

4. The frost prevention machine support with adjustable bottom structure according to claim 1, wherein the base seat formed by the base plate, the rotary plate, the guide rod, a pin shaft, and the direction control pin shaft, during assembly; first the rotary plate and the base plates are fixed with a pin shaft, the guide rod is installed in the guide groove on the base plates (41); then the upper connection ring and the lower connection ring are installed respectively, and the upper and lower connection rings must be reserved enough gap to ensure that the base plates are movable upward and downward relative to each other, such that each of the base plates of the base seat is able to circulated into the soil successively, reducing an striking external force, and the upper connection ring also satisfies a hook end of the hook bolts in the upper connection ring.

5. The frost prevention machine support with adjustable bottom structure according to claim 1, wherein connection of the four base plates is replaceable by being connected to link of the chain or soft steel wire rope, and this connection is beneficial to expansion of the lower base, and is more conducive to installation and stability of the frost prevention machine.

6. The frost prevention machine support with adjustable bottom structure according to claim 4, wherein the cross section of the rotary plate is a trapezoid structure which is wide at top and narrow at bottom, so as to reduce intensity of punch, and a wide end of the rotary plate and the base plates are connected with pin, and ensured that the rotary plate is rotatable relative to the base plates.

7. The frost prevention machine support with adjustable bottom structure according to claim 4, wherein a bending part of the guide rod is provided with a strip-shaped rotating plate direction control groove, a width of the control groove is 0.5 millimeters-1 millimeter larger than a diameter of the direction control pin shaft, a hole is disposed on an upper end of the guide rod; when the guide rod is exerted to move down, a tip end of the bending part of the guide rod exerts the external force to the rotary plate, so as to make a moving direction of the rotary plate deviate from a vertical direction and point downward; finally, the holes in the upper end of the guide rod and the hole on the guide groove are connected with bolt, such that the guide rod is always remained in a stabilizing state.
